(19) United States
(12) Patent Application Publication
(10) Pub. No.: US 2009/0094391 A1
(43) Pub. Date: Apr. 9, 2009

(54) STORAGE DEVICE INCLUDING WRITE BUFFER AND METHOD FOR CONTROLLING THE SAME

(76) Inventor: Keun Soo Yim, Yongin-si (KR)

Correspondence Address: MCNEELY BODENDORF LLP, P.O. BOX 34175, WASHINGTON, DC, 20043, US

(21) Appl. No.: 12/031,722

(22) Filed: Feb. 15, 2008

(30) Foreign Application Priority Data
Oct. 4, 2007 (KR) 10-2007-0099979

(51) Int. Cl. G06F 13/00

(52) U.S. Cl. 710/57; 710/52

(57) ABSTRACT

A storage device having a write buffer and a method of controlling the same, in which data having a relatively lower temporal and spatial locality from an input/output (I/O) operation request requested from the storage device is filtered using a filter. Accordingly, the I/O operation request may be performed in the storage device without passing through the write buffer.

### CROSS-REFERENCE TO RELATED APPLICATION

This application claims the benefit under 35 U.S.C. §119(a) of a Korean Patent Application No. 10-2007-0099979, filed on Oct. 4, 2007 in the Korean Intellectual Property Office, the entire disclosure of which is incorporated herein by reference.

### TECHNICAL FIELD

The following description relates to a storage device, and more particularly, to a storage device having a write buffer and a method of controlling the same.

### BACKGROUND

In a conventional storage device, a volatile write buffer has been used in order to improve input/output (I/O) performance. The buffer is effective for alleviating a relatively long I/O latency caused by a mechanical search process of the storage device. Specifically, when a cache hit occurs in the buffer, a read speed is increased. Also, when an acknowledgement is transmitted to a host after data is stored in a write buffer, a read speed measured in the host is increased. Storage devices such as a solid-state drive (SSD) use a dynamic random access memory (DRAM) buffer in order to improve the I/O performance.

A cache replacement policy of the conventional storage device has been designed in such a manner as to utilize temporal and spatial locality in an environment where the influence of the cache is not increased, regardless of presence/absence of a high level cache memory. In the case of a conventional least recently used (LRU) algorithm, when it is assumed that data currently accessed through a heuristic scheme is likely to be accessed later, the data currently accessed is cached. The LRU algorithm using temporal locality has been utilized in most conventional cache replacement policies.

However, the conventional storage device has problems in that an I/O operation request requested from a host is performed, and most hosts have their own cache memories (generally, DRAM), so that another temporal locality disadvantageously occurs in an I/O operation in the storage device. Specifically, when specific data is cached in a host computer at the time of reading the specific data, the specific data is not accessed in the storage device until the specific data is evicted from a host cache. As a result, the specific data does not have strong temporal locality in a write buffer of the storage device. Accordingly, in order to improve a write hit ratio with respect to a write operation request of the write buffer and reduce an amount of data stored in the write buffer, the conventional cache replacement policy is difficult to be applied to the write buffer of the storage device.

Also, there arise other problems due to the above-described problems in that even when a number of write operations with respect to the storage device is reduced in the storage device including the conventional write buffer, a write speed of the storage device is not improved, performance lifetime is not increased, and consumed power is not reduced.

Also, in the conventional storage device, the write buffer has relatively shorter write latency in comparison with the storage device, however, a write bandwidth is relatively narrow. As a result, when a large amount of write data is concentrated, the write buffer enters a bottleneck state.

### SUMMARY

In one general aspect, there is provided a method of controlling a storage device having a nonvolatile write buffer, in which a write operation is performed in a write buffer having a speed faster than that of a storage device by improving a write hit ratio with respect to a write operation request of a nonvolatile write buffer,.

In another general aspect, there is provided a method of controlling a storage device having a nonvolatile write buffer, in which a number of write operations is reduced in a storage medium of the storage device due to an improved write hit ratio with respect to a write operation request of the nonvolatile write buffer, and in which the write operation is performed in the write buffer where power consumption required for performing the write operation is relatively less than that in the storage device,.

In yet another general aspect, there is provided a method of controlling a storage device having a nonvolatile write buffer, in which data having a relatively lower temporal and spatial locality from an input/output (I/O) operation in the storage device is filtered using a locality filter, so that data is properly divided into the nonvolatile write buffer and the storage device.

In still another general aspect, there is provided a method of controlling a storage device having a nonvolatile write buffer, comprising: receiving an I/O operation request from a host; determining locality of data corresponding to the I/O operation request through a locality filter unit; and performing the I/O operation according to the request.

In yet another general aspect, there is provided a storage device comprising: a nonvolatile write buffer; a storage medium; and a locality filter unit which controls to determine locality of data corresponding to an I/O operation request received from a host and perform the I/O operation request in the nonvolatile write buffer or the storage medium.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating an internal memory hierarchy organization of an exemplary storage device having a write buffer;

FIG. 2 is a flowchart illustrating an exemplary process of controlling a storage device which performs a write operation request through a locality filter unit of the storage device and includes a nonvolatile write buffer;

FIG. 3 is a flowchart illustrating an exemplary process where an input/output (I/O) operation request is performed through a locality filter unit;

FIG. 4A is a flowchart illustrating an exemplary method for controlling a storage device by evicting data stored in a write buffer;

FIG. 4B is a flowchart illustrating an exemplary method for controlling a storage device by performing a read operation for delaying eviction of data stored in a write buffer;

FIG. 5 is a diagram illustrating a distribution of a write hit ratio performance through an exemplary locality filter unit according to a workload in a storage device having a nonvolatile write buffer; and

FIG. 6 is a diagram illustrating a distribution of write traffic according to a workload in a write buffer of a storage device according to an exemplary embodiment.

Throughout the drawings and the detailed description, the same drawing reference numerals will be understood to refer to the same elements, features, and structures.

### DETAILED DESCRIPTION

The following detailed description is provided to assist the reader in gaining a comprehensive understanding of the methods and systems described herein. Accordingly, various changes, modifications, and equivalents of the systems and methods described herein will be suggested to those of ordinary skill in the art. Also, descriptions of well-known functions and constructions are omitted to increase clarity and conciseness.

As a non-limiting illustration, a write buffer generally denotes a nonvolatile memory such as a battery-backed random access memory (RAM), a flash memory, a phase-change RAM (PRAM), a ferroelectric RAM (FRAM), and a magnetic RAM (MRAM).

Also as a non-limiting illustration, a storage device generally denotes a flash card such as a smartmedia, a multimedia card, and a secure digital, or a solid state drive (SDD) and a hybrid hard disk drive (HDD).

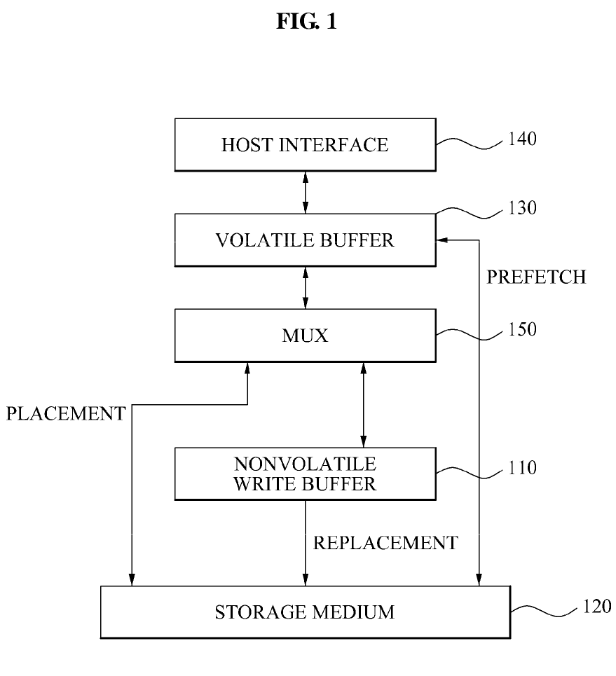

FIG. 1 illustrates an internal memory hierarchy organization of an exemplary storage device having a write buffer.

Referring to FIG. 1, a nonvolatile write buffer 110 of an exemplary storage device performs an input/output (I/O) operation request having locality, thereby reducing write traffic of a storage medium 120.

The nonvolatile write buffer 110 is transparent with respect to a volatile buffer 130, and also orthogonal to the volatile buffer 130.

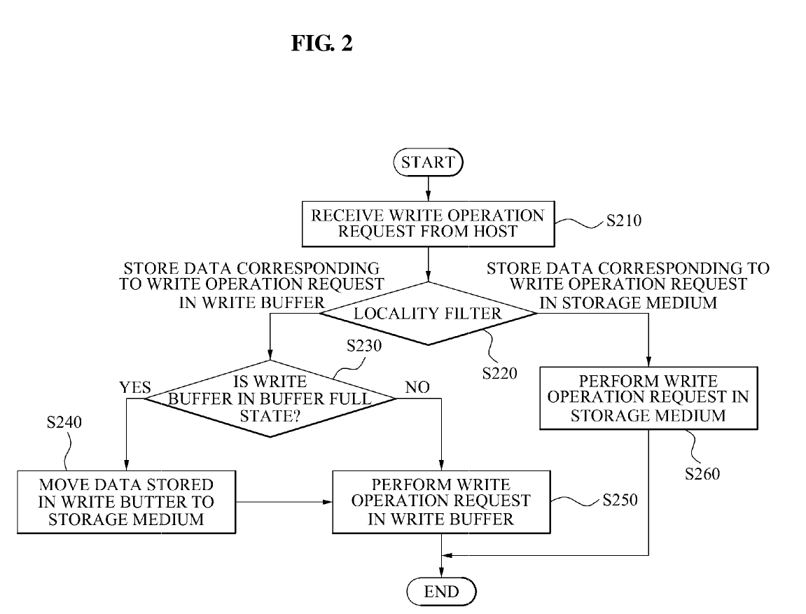

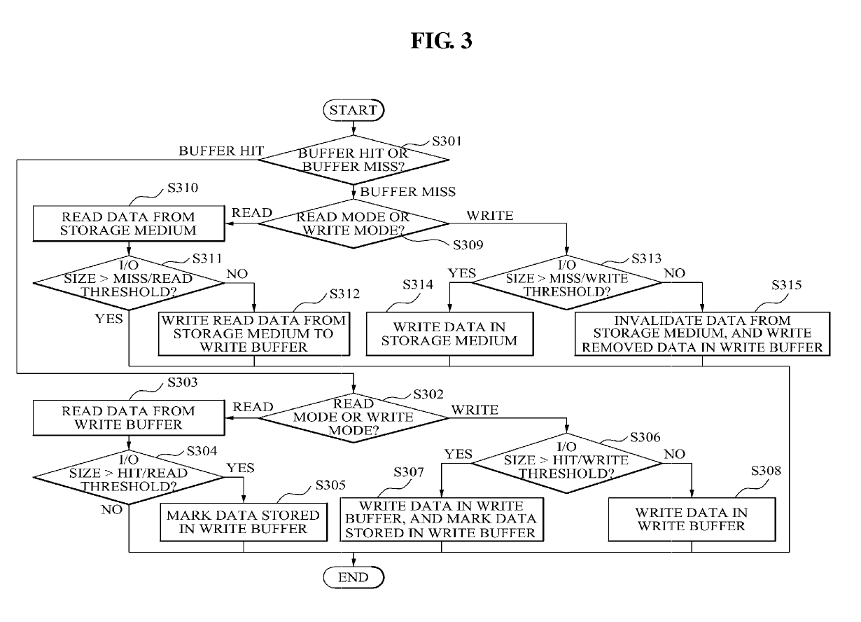

All I/O operation requests from a host are temporarily stored in the volatile buffer 130 through a host interface 140, and data corresponding to the I/O operation request is placed in or moved to a medium (a storage medium 120 or the write buffer 110) where the data is stored, based on temporal and spatial locality of the data. Specifically, temporal and spatial locality of the I/O operation request may be determined through a locality filter unit. For example, where the I/O operation request is a buffer hit and has strong locality, the data is stored in the nonvolatile write buffer 110, and where the I/O operation request does not have the strong locality, the data is directly stored in the storage medium 120. Also, where the nonvolatile write buffer 110 is in a buffer full state, and data corresponding to the I/O operation request having been previously transmitted is stored in the nonvolatile write buffer 110, the data may be evicted to the storage medium 120. In this case, the evicted data has weakest locality. An exemplary buffering algorithm performed through the locality filter unit will be herein described in detail with reference to FIGS. 2 and 3.

FIG. 2 illustrates an exemplary process of controlling a storage device which performs a write operation request through a locality filter unit of the storage device having a nonvolatile write buffer.

Referring to FIG. 2, in operation S210, a write operation request is received from a host. In operation S220, a locality filter unit determines temporal and spatial locality of data corresponding to the received write operation request, and performs the write operation request.

Where the data is required to be stored in a write buffer according to the determination result of the locality filter unit, whether the write buffer is in a buffer full state is determined in operation S230. Where the write buffer is in the buffer full state, data corresponding to a write operation request having been previously transmitted and stored in the write buffer is moved to a storage medium in operation S240, and the write operation request is performed in the write buffer in operation S250. Specifically, where the write operation request is a request with respect to a write operation, the data corresponding to the write operation is stored in the write buffer. Where the write buffer is not in the buffer full state, that is, where the write buffer has an enough space (slot) where the write operation request is able to be performed, the write operation request is performed in the write buffer in operation S250.

According to the determination result of the locality filter unit of operation S220, where the data corresponding to the write operation request is required to be stored in a storage medium, the write operation request is performed in the storage medium in operation S260. Specifically, the data corresponding to the write operation is stored in the storage medium.

The locality filter unit analyzes the write operation request, and determines whether the data corresponding to the write operation request is to be stored either in the write buffer or in the storage medium. The locality filter unit determines whether the write operation request is to be stored either in the write buffer or in the storage medium, so that cache pollution may be prevented from occurring, thereby improving a hit ratio of the write buffer. Also, the write operation request received from a host may be divided into and performed in the write buffer and the storage medium, thereby reducing a number of write operations with respect to the storage device, which results in improvement of a write speed of the storage device, increase in performance lifetime, and reduction in power consumption required for performing operations. An exemplary filtering algorithm performed in the locality filter unit will be herein described in detail with reference to FIG. 3.

FIG. 3 illustrates an exemplary process where an I/O operation request is performed through a locality filter unit.

Referring to FIG. 3, a locality filter unit according to an exemplary embodiment determines whether data is processed either in a write buffer or in a storage medium, in consideration of temporal and spatial locality of an I/O operation request received from a host and an I/O operation size according to read/write modes. Here, temporal and spatial locality of data corresponding to the I/O operation request may be determined by predicting and analyzing an access pattern of the write buffer, and the access pattern includes buffer hit information and buffer miss information. Also, the buffer hit information and the buffer miss information may include predetermined threshold information where workload characteristics based on an I/O operation size of the I/O operation request are applied. An I/O address includes, in principle, information effective for analyzing the access pattern. However, the I/O address has a problem in that costs required for maintaining a reference history with respect to an overall space are significantly increased. Thus, in one exemplary embodiment, the buffer hit information and the buffer miss information may be used.

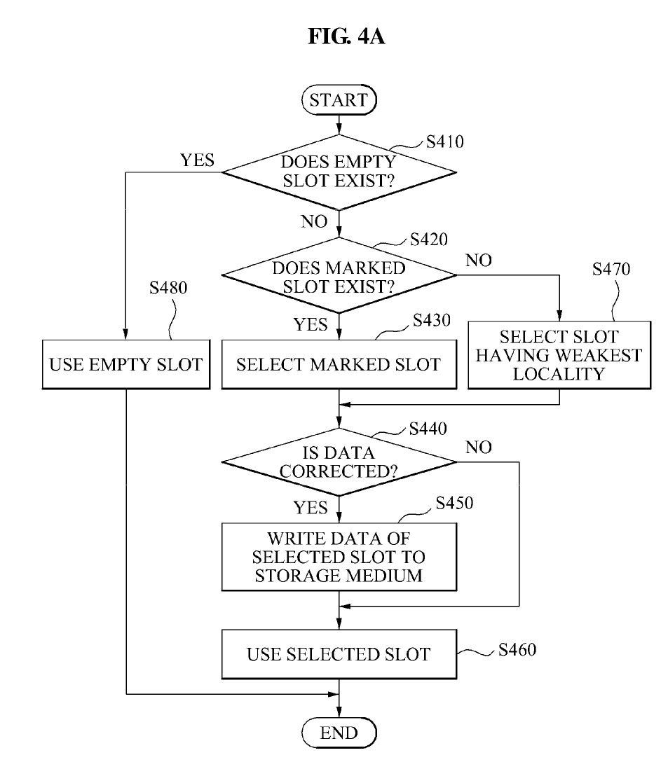

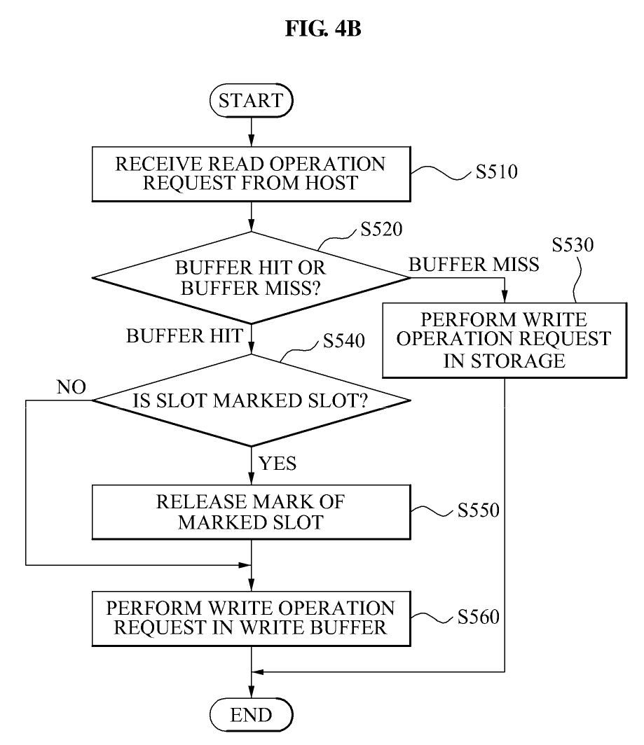

In operation S301, the locality filter unit determines whether a buffer hit or a buffer miss occurs in the write buffer where the data corresponding to the I/O operation request received from the host is processed. Where the buffer hit occurs in the write buffer according to the determination result of the locality filter, an I/O mode of the I/O operation request is determined in operation S302. In this regard, where the I/O operation request is a read mode, the data is read from the write buffer in operation S303, and whether the I/O operation size exceeds a hit/read threshold is determined in operation S304. Here, in the hit/read threshold, workload characteristics based on the I/O operation size of the I/O operation request are applied. Where the I/O operation size exceeds the hit/read threshold, data corresponding to an I/O operation request having been previously received and stored in the write buffer is marked in operation S305. This is for the purpose of replacing the data stored in the write buffer to be replaced with another data later. Specifically, where the data corresponding to the previously received I/O operation request is intended to be replaced with another data in the write buffer later in a state where the data stored in the write buffer is marked, the data corresponding to the previously received I/O operation request is replaced with data marked as an empty slot. The above-described exemplary eviction process will be described in detail with reference to FIG. 4.

Where the I/O operation request is a write mode according to the determination result of operation S302, whether the I/O operation size exceeds a hit/write threshold is determined in operation S306. Where the I/O operation size exceeds the hit/write threshold, the I/O operation request is performed in the write buffer and data corresponding to an I/O operation request having been previously received and stored in the write buffer is marked in operation S307. The marking in operation S307 is also for the purpose of replacing the data stored in the write buffer to be replaced with another data later. Specifically, where the data corresponding to the previously received I/O operation request is intended to be replaced with another data in the write buffer later in a state where the data stored in the write buffer is marked, the data corresponding to the previously received I/O operation request is replaced with data marked as an empty slot.

The exemplary hit/write may satisfy the following three conditions. First, the I/O operation request is a request with respect to the write operation. Second, the hit buffer occurs in the write buffer. Third, data stored in the write buffer is not stored in the storage medium. In this case, a write hit ratio denotes a ratio of a write hit count to a total write count. Accordingly, a hit/read mode and a read hit count may be specified in a manner similar to the hit/write threshold and the write hit count.

Where the I/O operation size is equal to or less than the hit/write threshold, the I/O operation request is performed in the write buffer. Specifically, data corresponding to the I/O operation request received in the write buffer is written in operation S308.

Where the I/O operation request is performed in the case of an occurrence of the buffer hit in the write buffer, a process where whether data stored in the write buffer is marked is determined and a process where a mark of the marked data is released may be further included.

In operation S301, the locality filter unit determines whether either a buffer hit or a buffer miss occurs in the write buffer where the data corresponding to the I/O operation request received from the host is processed. Where the buffer miss occurs in the write buffer according to the determination result of the locality filter, an I/O mode of the I/O operation request is determined in operation S309.

Where I/O operation request is a read mode, the data is read from the storage medium in operation S310, and whether the I/O operation size exceeds a miss/read threshold is determined in operation S311. Where the I/O operation size is equal to or less than the miss/read threshold, the read data is written from the storage medium to the write buffer in operation S312. Where the buffer miss occurs in the write buffer and the I/O operation request is the write mode according to the determination result of the locality filter of operations S301 and S309, whether the I/O operation size exceeds the miss/write threshold is determined in operation S313. Where the I/O operation size exceeds the miss/write threshold, the data is directly written to the storage medium in operation S314, and where the I/O operation size is equal to or less than the miss/write threshold, the data is invalidated from the storage medium, and the invalidated data is written to the write buffer.

As described above, the locality filter unit according to an exemplary embodiment determines whether corresponding data is processed either in the write buffer or in the storage medium, based on temporal and spatial locality of the I/O operation request received from a host and the I/O operation size according to read/write modes. Accordingly, the locality filter unit may reduce write traffic of the write buffer, and the write buffer may have an expandable endurance limit due to the reduction in the write traffic. Also, the I/O operation request may be divided into the write buffer and the storage medium, thereby widening a write bandwidth. The write buffer may be a nonvolatile write buffer, and as an illustration, may be any one of nonvolatile memories where an erase operation supported by in-place-update operation is not performed, such as an FRAM, a PRAM, and an MRAM. Also, the storage medium may be a flash memory having a multi-level cell (MLC).

Also, the temporal and spatial locality may be determined in such a manner that whether either the hit buffer or the miss buffer occurs is determined by performing a cache lookup operation, and metadata information of the data evicted from the write buffer is additionally stored. Also, a number of occurrences of the hit buffer may be maintained, thereby determining the temporal and spatial locality. As described above, in the hit/read threshold, the hit/write threshold, the miss/read threshold, and the miss/write threshold, workload characteristics based on the I/O operation size of the I/O operation request are applied, and the thresholds may be fixed while performing the I/O operation request, or dynamically vary through feed-back control. For example, where a write hit ratio with respect to a small sized I/O operation request is increased, and the write hit ratio with respect to a specific sized I/O operation request is significantly reduced, the thresholds may be determined in the specific sized I/O operation request.

As described above, where the buffer hit occurs in the write buffer, and data corresponding to the I/O operation request has strong locality, the data is not immediately evicted from the write buffer. However, since the last write hit of a given I/O operation sequence is sensed, the data stored in the write buffer is required to be evicted in order to improve the write hit ratio even though the write buffer hit occurs. Where the write miss buffer occurs, the write buffer needs a space where the data is stored in order to store the data. For this purpose, according to an exemplary embodiment, a slot occupying the write buffer is marked, and thus a process where an eviction operation is performed after a delay. For example, where the write buffer is in a buffer full state, marked data will be evicted at a later time. An eviction delay process may increase the write hit ratio. This will be herein described in detail with reference to FIGS. 4A and 4B.

FIG. 4A illustrates an exemplary method of controlling a storage device by evicting data stored in a write buffer.

Referring to FIG. 4A, whether an empty slot exists in the write buffer is determined in operation S410, and where the empty slot does not exist, that is, where the write buffer is in a buffer full state, whether a slot marked in the write buffer exists is determined in operation S420. Where the marked slot exists according to the determination result, the marked slot is selected in operation S430, and whether data stored in the selected slot is corrected is determined in operation S440. Where data stored in the selected slot is not corrected, that is, clean, the data stored in the selected slot is evicted. Specifically, the data of the marked slot is evicted in operation S460. Where the data stored in the selected slot is corrected, that is, dirty, the data of the selected slot is written to a storage medium in operation S450, and then evicted in operation S460.

Where the empty slot is determined to not exist according to the determination result of operation S410, whether a marked slot exists in the write buffer is determined in operation S420. Where the marked slot is determined to not exist according to the determination result of operation S420, a slot of data having a weakest locality is selected in operation S430, and whether data stored in the selected slot is corrected is determined in operation S440. Where the data stored in the selected slot is not corrected, that is, clean the selected slot is evicted. Specifically, the data of the marked slot is evicted in operation S460. Where the data of the selected slot is corrected, that is, dirty, the data of the selected slot is written to the storage medium in operation S450, and the data of the selected slot is evicted in operation S460.

Where the empty slot is determined to exist in the write buffer in operation S410, that is, where the write buffer is not in a buffer full state, the I/O operation request is performed in the empty slot in operation S480.

FIG. 4B illustrates an exemplary method of controlling a storage device by performing a read operation for delaying eviction of data stored in a write buffer.

Referring to FIG. 4B, a read operation request is received from a host in operation S510, and whether either a buffer hit or a buffer miss occurs in a write buffer is determined in operation S520. Where the buffer miss occurs in the write buffer, the read operation request is performed in a storage medium in operation S530. Where the buffer hit occurs in the write buffer, whether a corresponding slot of the write buffer where the data corresponding to the read operation request is stored is a marked slot is determined in operation S540. Where the slot is the marked slot, a mark of the mark slot is released in operation S550, and the read operation request is performed in the write buffer in operation S560. Also, where it is determined the slot is not the marked slot in operation S540, the read operation request is performed in the write buffer in operation S560.

Where the corresponding slot where the data corresponding to the read operation request exists is the marked slot in the case of an occurrence of the buffer hit while performing the read operation request, a mark of the marked slot is released. This is because the data corresponding to the read operation request exhibits substantially strong locality, which is different from a prediction acquired from the case where the corresponding slot is marked.

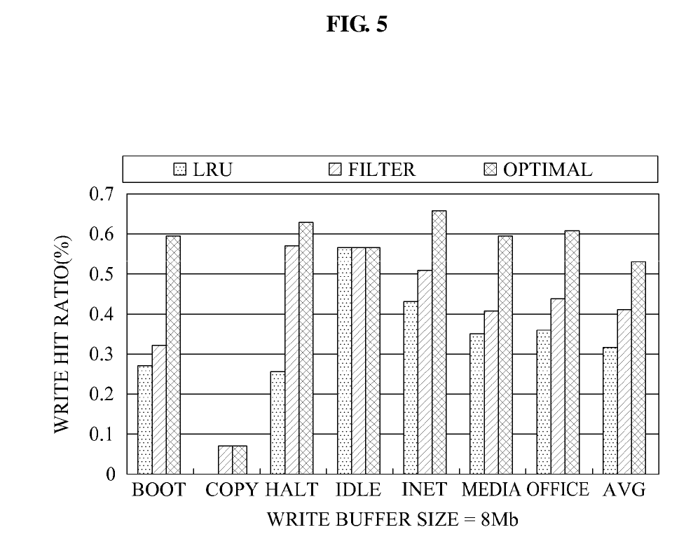

FIG. 5 illustrates a distribution of a write hit ratio performance through an exemplary locality filter unit according to a workload in a storage device having a nonvolatile write buffer.

FIG. 5 is acquired such that where a write buffer size is 8 Mb, an arbitrary threshold for each workload is determined for each locality filter unit, and a hit ratio of the write buffer is analyzed. Referring to FIG. 5, an algorithm of the locality filter unit according to the present exemplary embodiment exhibits a hit ratio improved by about 9% in comparison with a least recently used (LRU) algorithm. This is because write buffer pollution is removed by filtering out data having weak locality through the locality filter unit of the present exemplary embodiment.

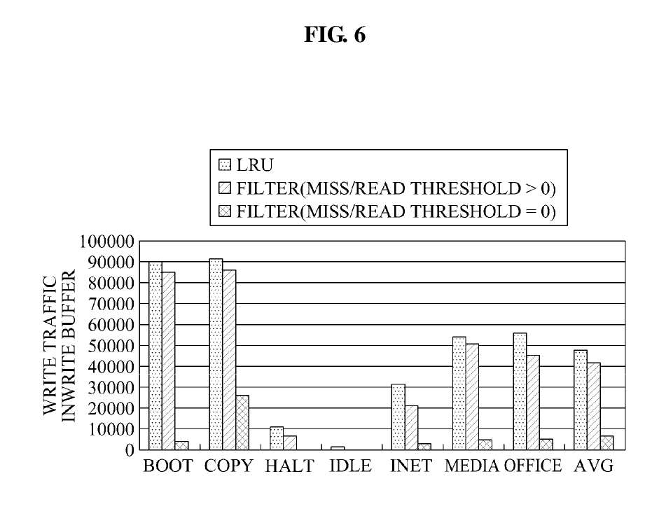

FIG. 6 illustrates a distribution of write traffic according to a workload in a write buffer of a storage device according to an exemplary embodiment.

Specifically, FIG. 6 illustrates a number of write operations performed in a write buffer of a storage device. Referring to FIG. 6, the write buffer is controlled through a locality filter unit in such a manner that data having a relatively lower temporal and spatial locality is filtered from an I/O operation request requested from a host to the storage device by using the locality filter unit, and the data is properly divided into a nonvolatile write buffer and the storage device. In the case of a Useful Region Localization (URL) algorithm, the write operation occurs in the write buffer only when the I/O operation request is received from the host, however, in the case of the locality filter unit algorithm, the I/O operation request received from the host is not directly stored in the write buffer, but filtered. As a result, the locality filter unit exhibits reduction in the write traffic of about 12% in comparison with the LRU algorithm.

An exemplary storage device includes a nonvolatile write buffer, a storage medium, and a locality filter unit which controls to determine locality of data corresponding to an I/O operation request received from a host and perform the I/O operation request in the nonvolatile write buffer or the storage medium. A temporal and spatial locality of the I/O operation request may be determined through the locality filter unit, and the I/O operation request received from the host may be controlled to be performed either in the write buffer or in the storage medium according to the determined locality.

The methods of controlling a storage device having a nonvolatile write buffer according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, a write operation may be performed in a write buffer having a speed faster than that of a storage device by improving a write hit ratio with respect to a write operation request of a nonvolatile write buffer, thereby improving a write speed of the storage device.

A number of write operations may be reduced in a storage medium of the storage device due to an improved write hit ratio with respect to the write operation request of the nonvolatile write buffer, thereby increasing a performance lifetime of the storage device, and in which a write operation is performed in a write buffer where power consumption required for performing the write operation is relatively less than that in the storage device, thereby reducing power consumption of the storage device.

Data having a relatively lower temporal and spatial locality from an I/O operation in the storage device may be filtered using a locality filter, so that data is divided into the nonvolatile write buffer and the storage device, thereby reducing write traffic.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling a storage device having a nonvolatile write buffer, the method comprising:
receiving an input/output (I/O) operation request from a host;
determining locality of data corresponding to the I/O operation request through a locality filter unit; and
performing the I/O operation according to the request.

2. The method of claim 1, wherein the performing of the I/O operation according to the request comprises:
where the data is to be stored in the nonvolatile write buffer according to the result of the determining of locality of data, determining whether the nonvolatile write buffer is in a buffer full state, and performing the I/O operation according to the request in the nonvolatile write buffer.

3. The method of claim 2, wherein the performing of the I/O operation according to the request comprises:
where the nonvolatile write buffer is in the buffer full state, moving data stored in the nonvolatile write buffer to a storage medium; and
performing the I/O operation according to the request in the nonvolatile write buffer.

4. The method of claim 2, wherein the performing of the I/O operation according to the request comprises:
where the nonvolatile write buffer is not in the buffer full state, performing the I/O operation according to the request in the nonvolatile write buffer.

5. The method of claim 1, wherein where the data is to be stored in a storage medium according to the result of the determining, the performing comprises performing the I/O operation according to the request in the storage medium.

6. The method of claim 1, wherein the locality of the data includes information acquired by predicting and analyzing an access pattern of the nonvolatile write buffer, the access pattern includes buffer hit information and buffer miss information, and the buffer hit information and the buffer miss information include predetermined threshold information according to workload characteristics based on an I/O size of the I/O operation request.

7. The method of claim 6, wherein the determining of locality of data comprise:
determining whether either a buffer hit or a buffer miss occurs; and
where the buffer hit occurs and the I/O operation request is a read mode, reading the data from the nonvolatile write buffer, and determining whether the I/O size exceeds a hit/read threshold.

8. The method of claim 7, wherein where the I/O size exceeds the hit/read threshold, the method further comprises marking the data stored in the nonvolatile write buffer.

9. The method of claim 6, wherein where the buffer hit occurs and the I/O operation request is a write mode, determining whether the I/O size exceeds a hit/write threshold.

10. The method of claim 9, wherein where the I/O size exceeds the hit/read threshold, the method further comprises performing the I/O operation request in the nonvolatile write buffer, and marking the data stored in the nonvolatile write buffer.

11. The method of claim 9, wherein where the I/O size is equal to or less than the hit/write threshold, the method further comprises performing the I/O operation request in the nonvolatile write buffer.

12. The method of claim 6, wherein where the buffer miss occurs and the I/O operation request is a read mode, reading the data from the storage medium, and determining whether the I/O size exceeds a miss/read threshold.

13. The method of claim 12, wherein where the I/O size is equal to or less than the miss/read threshold, the method further comprises writing the read data from the storage medium to the nonvolatile write buffer.

14. The method of claim 6, wherein where the buffer miss occurs and the I/O operation request is a write mode, determining whether the I/O size exceeds a miss/write threshold.

15. The method of claim 14, wherein where the I/O size exceeds the miss/write threshold, the method further comprises writing the data in the storage medium.

16. The method of claim 14, wherein where the I/O size is equal to or less than the miss/write threshold, the method further comprises writing the invalidated data in the nonvolatile write buffer, and invalidating the data in the storage medium.

17. The method of claim 1, further comprising evicting the data stored in the nonvolatile write buffer by analyzing a space of the nonvolatile write buffer.

18. The method of claim 17, wherein the evicting of the data comprises:
determining whether an empty slot exists; and
where the empty slot does not exist, determining whether a marked slot exists, selecting the marked slot where the marked slot exists, and determining whether data of the selected slot is corrected.

19. The method of claim 18, wherein where the data of the selected slot is not corrected, evicting the data of the selected slot.

20. The method of claim 19, wherein where the data of the selected slot is corrected, writing the data of the marked slot in the storage medium and evicting the data of the selected slot.

21. The method of claim 17, wherein the evicting of the data comprises: determining whether an empty slot exists; and
where the empty slot does not exist, determining whether a marked slot exists, selecting a slot having a weakest locality where the marked slot does not exist, and determining whether data included in the selected slot is corrected.

22. The method of claim 21, wherein where the data of the selected slot is not corrected, evicting the data of the selected slot.

23. The method of claim 21, wherein where the data of the selected slot is corrected, writing the data of the selected slot in the storage medium and evicting the data of the selected slot.

24. A storage device comprising:
a nonvolatile write buffer;
a storage medium; and
a locality filter unit which controls to determine locality of data corresponding to an I/O operation request received from a host and perform the I/O operation request in the nonvolatile write buffer or the storage medium.

25. The storage device of claim 24, wherein the nonvolatile write buffer is any one of a ferroelectric RAM (FRAM), a phase-change RAM (PRAM), and a magnetic RAM (MRAM), and the locality filter unit is implemented by software embedded in the storage device.
